(19) United States
(12) Patent Application Publication
(10) Pub. No.: US 2021/0233129 A1
(43) Pub. Date: Jul. 29, 2021

(54) MACHINE LEARNING BASED INTELLIGENT PARTS CATALOG

(71) Applicant: Dell Products L. P., Round Rock, TX (US)

(72) Inventors: Sathish Kumar Bikumala, Round Rock, TX (US); Deepak NagarajeGowda, Cary, NC (US)

(21) Appl. No.: 16/752,761

(22) Filed: Jan. 27, 2020

(51) Int. Cl. G06Q 30/06; G06Q 10/08; G06N 20/00; G06K 9/62

(52) U.S. Cl. CPC G06Q 30/0603; G06Q 30/0629; G06K 9/6267; G06N 20/00; G06Q 10/0875

(57) ABSTRACT

As an example, a server may host an intelligent parts catalog that uses multiple machine learning models to identify a similarity between each part and one or more other parts in the intelligent parts catalog based on attributes of each of the parts in the intelligent parts catalog. For example, the attributes may include size, form factor, electrical characteristics, power consumption, price, regulations complied with, reliability, taxonomy, and the like. If a particular part becomes unavailable (e.g., due to weather, labor strike, or manufacturing issues), the intelligent parts catalog may provide a similarity score with each similar part that quantifies how similar each similar part is to the particular part. In this way, the same bill of materials can be used to identify parts to create a first product for a quality-conscious market, a second product for a price-sensitive market, and a third product to comply with local regulations.

### BACKGROUND OF THE INVENTION

### Field of the Invention

This invention relates generally to a parts catalog and more particularly to using machine learning to create an intelligent parts catalog in which a similarity score indicates a similarity of other parts to a particular part.

### DESCRIPTION OF THE RELATED ART

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

A manufacturer of electronic devices, such as computing devices, may have a global supply chain to provide components used to assemble the electronic devices. To reduce the impact of unforeseen events (e.g., severe weather, labor unrest, or the like) on the supply chain, the manufacturer will have, for each part, multiple suppliers, including a primary supplier and at least one secondary source. In some cases, the manufacturer may build the same product using different parts to meet local laws (e.g., regulatory compliance). For example, the European Union (EU) may require that devices sold in the EU satisfy certain regulatory requirements. In addition, the manufacturer may manufacture two different versions of the same products to satisfy different market requirements. For example, a first version may use higher quality parts to target quality-conscious markets while a second version may use lower priced parts to target price-sensitive markets. Thus, the manufacturer may manufacture 3 or more versions, (i) a quality-conscious version, (ii) a price-sensitive version, and (iii) one or more versions to satisfy laws in particular markets.

Current parts catalogs are manually maintained and have no built-in intelligence to identify alternate parts if a particular part becomes unavailable. In addition, current parts catalogs do not quantify how similar the alternate parts are to the particular part.

### SUMMARY OF THE INVENTION

This Summary provides a simplified form of concepts that are further described below in the Detailed Description. This Summary is not intended to identify key or essential features and should therefore not be used for determining or limiting the scope of the claimed subject matter.

As an example, a server may host an intelligent parts catalog that uses multiple machine learning models to identify a similarity between each part and one or more other parts in the intelligent parts catalog based on attributes of each of the parts in the intelligent parts catalog. For example, the attributes may include size, form factor, electrical characteristics, power consumption, price, regulations complied with, reliability, taxonomy, and the like. If a particular part becomes unavailable (e.g., due to weather, labor strike, or manufacturing issues), the intelligent parts catalog may provide a similarity score with each similar part that quantifies how similar each similar part is to the particular part. In this way, the same bill of materials can be used to identify parts to create a first product for a quality-conscious market, a second product for a price-sensitive market, and a third product to comply with local regulations.

### BRIEF DESCRIPTION OF THE DRAWINGS

A more complete understanding of the present disclosure may be obtained by reference to the following Detailed Description when taken in conjunction with the accompanying Drawings. In the figures, the left-most digit(s) of a reference number identifies the figure in which the reference number first appears. The same reference numbers in different figures indicate similar or identical items.

FIG. 1 is a block diagram of a system that includes a server to host an intelligent parts catalog, according to some embodiments.

FIG. 2 is a block diagram of a system to create an intelligent parts catalog, according to some embodiments.

FIG. 3 is a block diagram of a system to determine multiple bill of materials for multiple versions of a product, according to some embodiments.

FIG. 4 is a block diagram of a system that uses a similarity scoring model to identify parts similar to a particular part, according to some embodiments.

FIG. 5 is a block diagram illustrating an exemplary taxonomy, according to some embodiments.

FIG. 6 is a block diagram of a system in which data associated with a new part is added to an intelligent parts catalog, according to some embodiments.

FIG. 7 is a flowchart of a process that includes part numbers of similar parts ordered based on a similarity score of each similar part to a particular part, according to some embodiments.

FIG. 8 is a flowchart of a process that includes creating multiple product versions using an intelligent parts catalog, according to some embodiments.

FIG. 9 is a flowchart of a process that includes adding a new part to an intelligent parts catalog based on a taxonomy of the new part, according to some embodiments.

FIG. 10 illustrates an example configuration of a computing device that can be used to implement the systems and techniques described herein.

### DETAILED DESCRIPTION

For purposes of this disclosure, an information handling system (IHS) may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an information handling system may be a personal computer (e.g., desktop or laptop), tablet computer, mobile device (e.g., personal digital assistant (PDA) or smart phone), server (e.g., blade server or rack server), a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, touchscreen and/or video display. The information handling system may also include one or more buses operable to transmit communications between the various hardware components.

The systems and techniques described herein enable an intelligent parts catalog to be created using multiple machine learning models. The intelligent parts catalog provides a variety of advantages to a manufacturer. For example, the intelligent parts catalog enables the manufacturer to identify similar parts, ordered based on a similarity score, to an existing part being used in the assembly of a product that may have become (temporarily or permanently) unavailable. As another example the intelligent parts catalog enables the manufacturer to provide a bill of materials for a particular product and have the intelligence parts catalog create multiple bill of materials for multiple versions of the particular product, such as, for example, a price-sensitive version, a quality-conscious version, a version that complies with local laws and/or regulations, and the like.

As an example, a server may include one or more processors, and one or more non-transitory computer readable media to store instructions executable by the one or more processors to perform various operations. For example, the operations may include receiving, by an intelligent parts catalog hosted by the server, a query comprising a part number corresponding to a particular part used to manufacture a product. The operations may include determining a particular set of attributes (e.g., size, form factor, electrical characteristics, power consumption, price, regulatory compliance, reliability, taxonomy, and the like) associated with the particular part. The operations may include performing a comparison of the particular set of attributes to individual sets of attributes associated with individual part numbers in the intelligent parts catalog. The operations may include determining one or more similar parts to the particular part based on the comparison. The operations may include determining a similarity score associated with at least a portion of the individual part numbers. The operations may include determining one or more similar parts to the particular part based on the associated similarity score. The operations may include providing results including one or more similar part numbers corresponding to the one or more similar parts, the one or more similar part numbers ordered in descending order based on the associated similarity score. The operations may include determining service request data associated with a plurality of products. The operations may include determining product return data associated with the plurality of products. The operations may include determining a reliability score associated with individual parts used in the plurality of products based at least in part on the service request data and the product return data. The operations may include clustering the individual parts having a similar reliability score using machine learning clustering. For example, a first part and second part may have the similar reliability score based on determining that a first reliability score of the first part and a second reliability score of the second part differ by less than a predetermined amount. The reliability score may be added as an attribute to a set of attributes associated with the individual parts. The operations may include classifying, using a machine learning classifier, the individual parts, based on the reliability score associated with the individual parts. The operations may include creating a machine learning quality model based on the parts catalog and the reliability score associated with the individual parts. The operations may include determining price data associated with the individual parts. The operations may include adding the price data as an attribute to individual sets of attributes associated with the individual parts. The operations may include receiving a bill of materials identifying a particular set of parts used to build a product. The operations may include determining a first set of parts comprising reliable parts having a reliability score greater than a first threshold amount. For example, the first set of parts may be used to build the product for a quality-conscious market. The operations may include determining a second set of parts comprising inexpensive parts having a reliability score greater than a second threshold amount and a price less than a third threshold amount. For example, the second set of parts may be used to build the product for a price-sensitive market. The operations may include determining a third set of parts comprising compliant parts that comply with a set of regulations associated with a particular location (e.g., European Union, United States, or another location). For example, the third set of parts may be used to build the product for the particular location. The operations may include determining parts data associated with each part in the intelligent parts catalog. The operations may include determining taxonomy data associated with each part in the intelligent parts catalog. The operations may include determining the similarity score associated with each part in the parts catalog based at least in part on the parts data and the taxonomy data. The operations may include creating a machine learning taxonomy model based at least in part on the similarity scores.

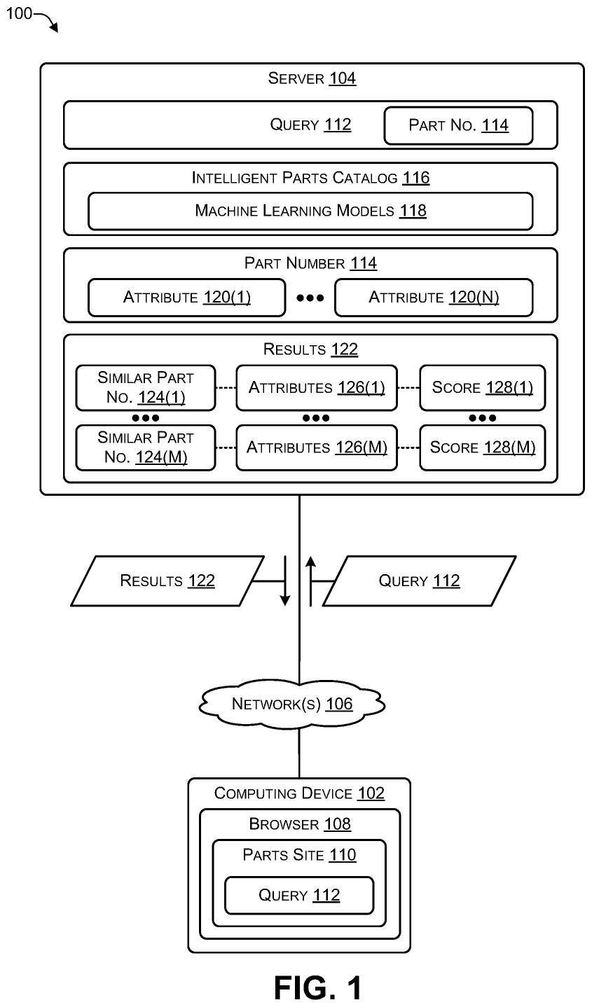

FIG. 1 is a block diagram of a system 100 that includes a server to host an intelligent parts catalog, according to some embodiments. The system 100 includes a computing device 102 connected to a server 104 via at least one network 106. The computing device 102 may include a browser 108 that enable the user to browse to a parts site 110 and send a query 112 to an intelligent parts catalog 116 hosted by the server 104.

The query 112 may include a part number 114 identifying a part that is used in the assembly of a product, such as a computing device. For example, the computing device may be a rackmount server, a desktop computing device, a laptop, a tablet, a smart watch, a smart phone, or another type of computing device. The quarry 112 may be a request to identify, in the intelligent parts catalog 116, one or more parts similar to the part identified by the part number 114. The intelligent parts catalog 116 may be created and maintained using one or more machine learning models 118, as described herein.

The part number 114 may include multiple attributes, such as an attribute 120(1) to an attribute 120(N) (N>0). For example, the attributes 120 may include taxonomy data, and other attributes of the part identified by the part number 114. To illustrate, the attributes 120 of a memory part may include a capacity (e.g., 4 gigabytes (GB), 8 GB, 16 GB, or the like) of the memory, a speed (e.g., DDR3, DDR4, or the like) of the memory, a form factor (e.g., dual inline memory module (DIMM), small outline DIMM (SO-DIMM), M.2, non-volatile memory express (NVME), or the like) of the memory, a taxonomy associated with the memory, and other attributes related to the memory. The attributes 120 may include historical data (e.g., procurement data), quality data (e.g., determined as described herein), sub-assemblies that include the part, compatibility (e.g., behavioral characteristics), similarity (e.g., physical and electrical characteristics), version compatibility, and the like.

The intelligent parts catalog 116 may determine the attributes 120 associated with the part number 114 and identify similar parts 124(1) to 124(M) (M>0). Each of the similar parts 124 may have associated attributes and a similarity score. For example, the similar part number 124(1) may have associated attributes 126(1) and an associated similarity score 128(1). The similar part number 124(M) may have associated attributes 126(M) and an associated similarity score 128(M). The attributes 126 may be similar to the attributes 120 associated with the part number 114. The score 128 may be derived from the similarity of the similar part number 124 to the part number 114. The similar parts 124 may be ordered based on a descending similarity score 128. For example, the similar part number 124(1) may have the highest similarity score 128(1) when comparing the similar part number 124(1) to the part number 114.

Based on identifying the similar parts 124, the server 104 may provide results 122 in response to receiving the query 112. The results 122 may include the similar part numbers 124. In some cases, the results 122 may include the associated attributes 126, the similarity score 128, or both.

Thus, a user may send a query that includes a part number to an intelligent parts catalog that is hosted by a server. The intelligent parts catalog may identify similar parts to a particular part identified by the part number based on the attributes associated with the particular part and based on attributes associated with the similar parts. The intelligent parts catalog may provide, in response to the query, results that include similar part numbers ordered based on a similarity score. The similarity score may indicate how similar each similar part is to the particular part. For example, the similarity score may be a percentage, such as from 0 (dissimilar) to 100 (similar), that indicates the similarity of a similar part to the particular part. In this example, 100 may indicate a similar part that is so similar that the similar part can take the place of the part in a product with little or no impact to the product. For example, a second part may be identified as being 100% similar to a first part indicating that the second part may have a similar (or identical) quality level, a similar (or identical) price level, a similar (or identical) form factor, a similar (or identical) performance, and the like. Because of the similarity score, the second part may be substituted for the first part in the product with little or no impact to the quality of the product, the price of the product, the performance of the product, and the like. While the examples herein use a similarity score as a percentage from 0 to 100, the similarity score may of course be scaled to other ranges, such as a fraction between zero and one, where one indicates a similar part, and zero indicates a dissimilar part.

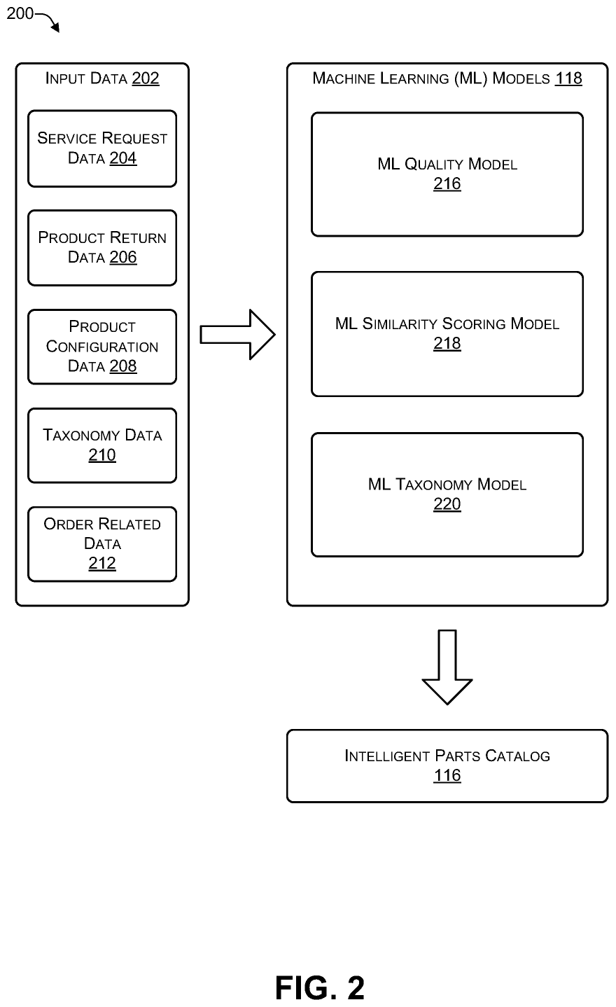

FIG. 2 is a block diagram of a system 200 to create an intelligent parts catalog, according to some embodiments. The system 200 illustrates how the intelligent parts catalog 116 may be created.

Input data 202 may include service request data 204, product return data 206, product configuration data 208, taxonomy data 210, and order related data 212 (including, for example, quotes, sales orders, purchase orders, invoices, and bill of materials (BOM). The service request data 204 may identify data associated with service requests initiated by customers to provide service to a particular product. The product return data 206 may include data associated with products that have been returned due to defects or other issues. The product configuration data 208 may include data associated with parts associated with a particular configuration of a product. The taxonomy data 210 may include data associated with a taxonomy of each part in each particular product manufactured by the manufacturer. The order related data 212 may include sales quotes, sales orders, purchase orders, invoices, and bill of materials associated with each part of each particular product.

The input data 202 may be used as input to multiple machine learning models 118. For example, the machine learning models 118 may include a machine learning quality model 216, a machine learning similarity scoring model 218, and a machine learning taxonomy model 220. The input data 202 may be used as training data to create of the machine learning models 216, 218, 220. The machine learning models 216, 218, 220 may be used to create the intelligent parts catalog 116, as described herein.

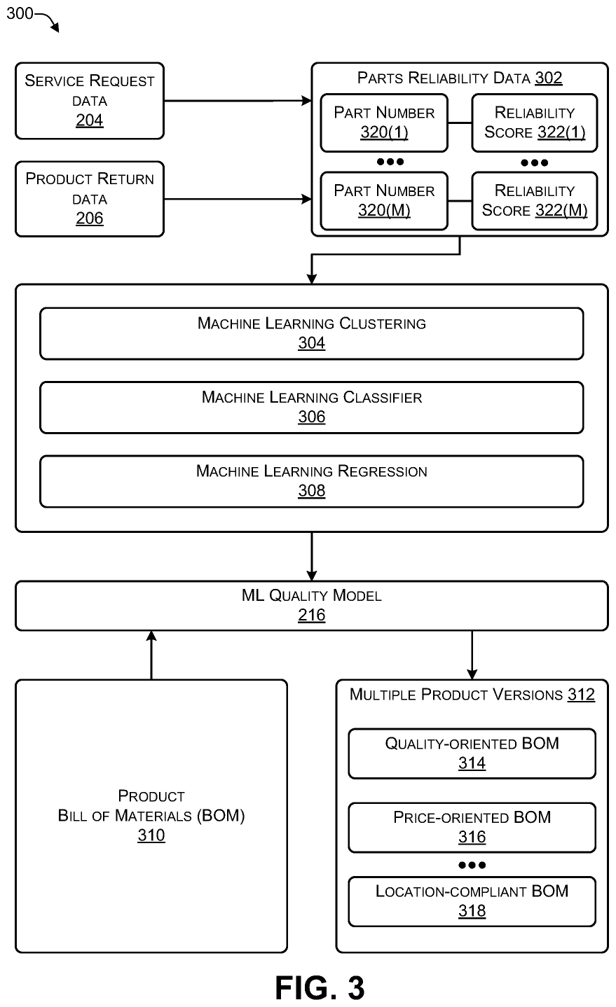

FIG. 3 is a block diagram of a system 300 to determine multiple bill of materials for multiple versions of a product, according to some embodiments. The system 300 illustrates how the machine learning quality model 216 may be created.

The service request data 204 and the product return data 206 may be used as input to determine parts reliability data 302. For example, parts that caused service requests (e.g., technician is sent to customer location to address product issue) or product returns (e.g., customer returns product due to an issue) may be flagged as having a lower quality whereas other parts that were not subject to service requests or product returns may be flagged as having a higher quality. The parts reliability data 302 may be determined based on how many of a particular part has been used in a product, how many times the particular part has caused a service request, and how many times the particular product has caused a product return. For example, a first part may have been used in 1000 computing devices and the first part may have been responsible for 40 service requests and 60 product returns. The first part may be considered 90% reliable (e.g., (40+60)/1000=10% unreliable). As another example, a second part may have been used in 2000 computing devices and the second part may have been responsible for 100 service requests and 200 product returns. The second part may be considered 85% reliable (e.g., (100+200)/2000=15% unreliable). In this way, the parts reliability data 302 may be normalized by interpolating or extrapolating to enable comparisons between two or more parts.

Machine learning clustering 304 may be used on the parts reliability data 302 to cluster each part based on the reliability associated with each part, e.g., parts with a 99% reliability score in a first cluster, parts with a 98% reliability score in a second cluster, and so on. For example, the machine learning clustering 304 may use K-means clustering, mean shift clustering, density based spatial clustering with noise, expectation maximization clustering using Gaussian mixture models, agglomerative hierarchical clustering, or the like. The machine learning clustering 304 may thus cluster (e.g., group) parts having a same (or similar) reliability score as compared to parts in other clusters.

A machine learning classifier 306 may be used to classify whether a set of parts in a particular cluster are of sufficient reliability to warrant including in a product. For example, parts in clusters with a 95% reliability score or higher may be classified as usable while the parts in the remaining clusters may be classified as unusable. As another example, parts in clusters having a reliability score between 95% and 100% may be classified as extremely reliable, parts in clusters having a reliability score between 90% and 94% may be classified as very reliable, parts in clusters having a reliability score between 80% and 89% may be classified as adequately reliable, and parts having a reliability score below 80% may be classified as unreliable. For example, if a product is being made for a price-conscious market, parts that are classified as very reliable or adequately reliable may be used to save costs. The machine learning classifier 306 may be a type of supervised learning, e.g., learning where a training set of correctly identified observations is available and may be implemented using Naive Bayes, support vector machines, Random Forest, Neural Networks, or the like.

A machine learning regression model 308 (e.g., using linear regression, least squares, or the like) may be used to perform regression to create a quality score for each part in the intelligent parts catalog 116. For example, the quality score may be based on performing clustering using the machine learning clustering 304. The machine learning clustering 304, the machine learning classifier 306, and the machine learning regression 308 may be used to create the machine learning quality model 216.

One use of the machine learning quality model 216 may be to use a product bill of materials 310 (e.g., a bill of materials listing parts used to build a product) as input to produce bill of materials for multiple product versions 312. For example, a quality-oriented bill of materials 314 may identify parts having a relatively high reliability score 322 (e.g., 90% or higher) to create a particular product. A price-oriented bill of materials 316 may identify parts having a lower price than the parts identified in the quality-oriented bill of materials 314. The price-oriented bill of materials 316 may identify parts having a lower reliability score 322 (e.g., 80% or higher) than the parts identified in the quality-oriented bill of materials 314. The location compliant bill of materials 318 may include parts that are compliant with laws or regulations associated with a particular location. For example, a particular location, such as the European Union, may specify that computers sold in the European Union comply with a set of regulations. The location-compliant bill of materials 318 may specify parts that enable the completed product to comply with the set of regulations of the European Union, thereby enabling the manufacturer to sell products built using the location-compliant bill of materials 318 in the European Union.

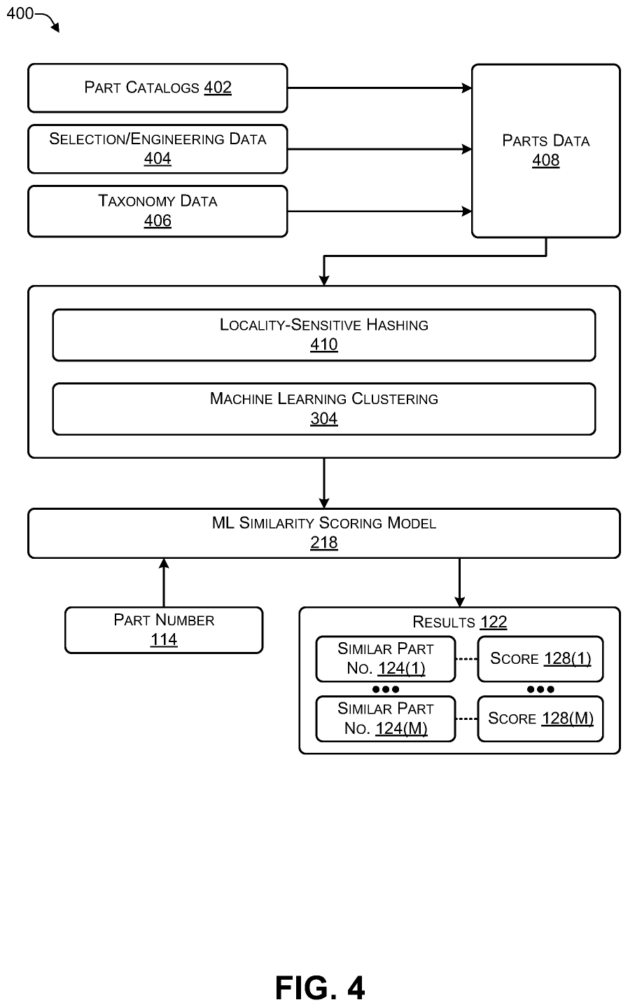

FIG. 4 is a block diagram of a system 400 that uses a similarity scoring model to identify parts similar to a particular part, according to some embodiments. The system 400 illustrates how similar parts may be identified using a similarity score associated with each part.

Data from various part catalogs 402, selection/engineering data 404, and taxonomy data 406 may be gathered to create parts data 408. The selection/engineering data 404 may include which particular attributes were used to select a particular part for a particular product. For example, in a portable computing device, such as a laptop or a tablet, low power consumption may be an important attribute. Therefore, when selecting parts for a portable computing device, the selection/engineering data 404 may indicate that a relatively low power consumption attribute may be important and may be given more weight than other attributes, such as price, reliability, or the like.

A locality sensitive hashing algorithm 410 may be used on the parts data 408. The locality sensitive hashing algorithm 410 may hash, using the parts data 408, similar parts into the same “buckets” with high probability. In this way, similar parts may end up in the same bucket. For example, a first part in the second part may be in the same bucket based on having the same capacity, the same form factor, the same size, the same pinout, the same capacity, and other similar (or same) attributes. The locality sensitive hashing for 410 and the machine learning clustering 304 may be used to create the similarity score 128 associated with each part number 124. For example, when the machine learning similarity scoring model to 18 is provided the part number 114, the machine learning similarity scoring model to 18 may provide the results 122 in which each similar part number 124 is provided in the results 122 ordered in descending order based on the corresponding similarity score 128. For example, if the similarity score 128M) is 100%, then the similar part number 124(M) may be 100% interchangeable with the part number 114. If the similarity score 128(M) is 80%, then the similar part number 124(M) may be interchangeable with the part number 114 80% of the time (e.g., in 80% of the products). For example, the part number 124 may be interchangeable when low power consumption is not a consideration for the product. The machine learning clustering 304 may group parts in such a way that parts in the same group (called a cluster) are more similar (e.g., based on the attributes of each part) to each other than to those in other groups (clusters).

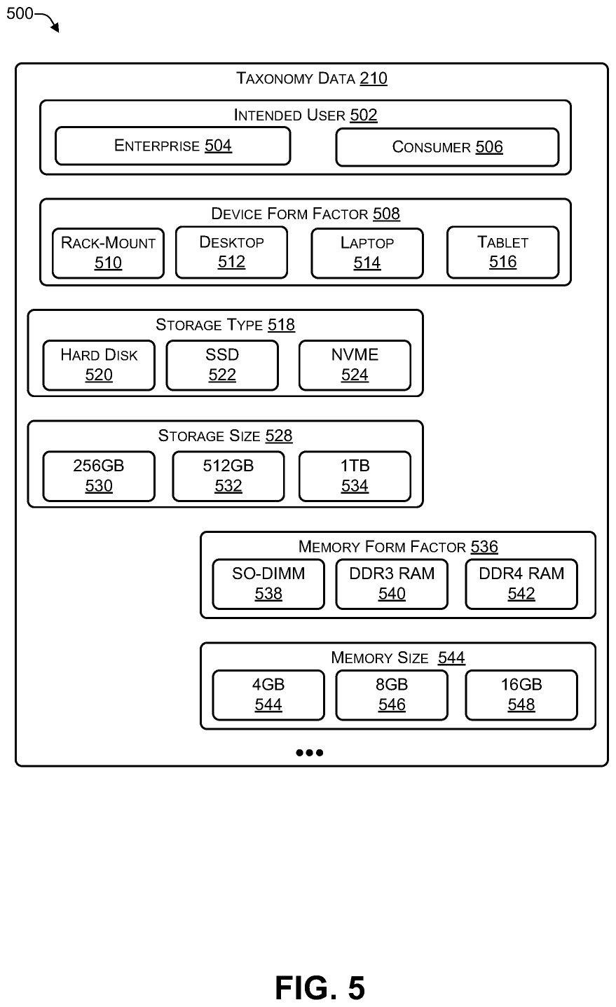

FIG. 5 is a block diagram 500 illustrating an exemplary taxonomy, according to some embodiments. FIG. 5 is an example of a portion of the taxonomy data 210. For example, an intended user 502 may be either an enterprise customer 504 or a consumer 506. A device form factor 508 may be a rackmount device 510, a desktop 512, a laptop 514 or a tablet 516. A storage type 518 of a storage device may be a hard disk 520, a solid-state drive (SSD) 522, or a non-volatile memory express (NVME) 524, or the like. A storage size 528 of a storage device may include 256 GB 530, 512 GB 532, and 1 TB 534. A memory form factor 536 of a memory device may include a SO-DIMM 538, a DDR3 RAM 540, a DDR4 RAM 542, or the like. A memory size of a memory device may be one of 4 GB 544, 8 GB 546 or 16 GB 548. FIG. 5 is intended merely as an illustration of the type of data that may be included in the taxonomy data 210 and is not intended to be exhaustive.

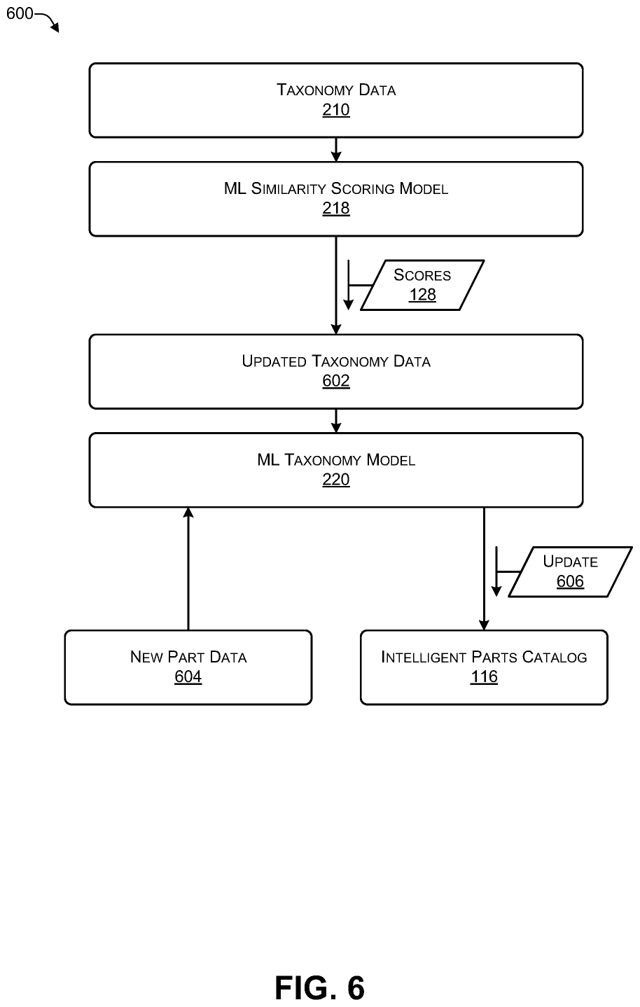

FIG. 6 is a block diagram of a system 600 in which data associated with a new part is added to an intelligent parts catalog, according to some embodiments. The taxonomy data 210 may be processed using the machine learning similarity scoring model 218 by determining a similarity score associated with each part in the taxonomy data 210 to create updated taxonomy data 602. The updated taxonomy data 602 may use the similarity scores to group parts with a similar taxonomy. For example, if a first part and a second part have the same taxonomy, then both the first part and the second part may have a same (or similar, e.g., within a predetermined threshold) similarity score.

When a new part is to be added to the intelligent parts catalog 116, new part data 604 (e.g., data associated with the new part) may be processed using the machine learning taxonomy model 220 to identify the taxonomy of the new part based on the new part data 604. The machine learning taxonomy model 220 may perform an update 606 of the intelligent parts catalog 116 to include the new part data 604 of the new part.

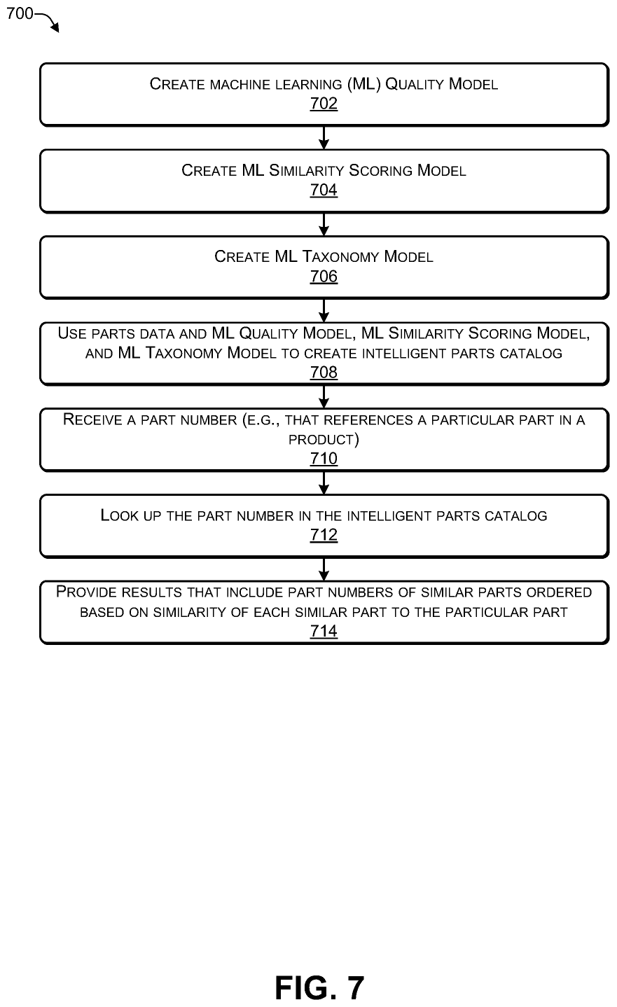

In the flow diagrams of FIGS. 7, 8, and 9, each block represents one or more operations that can be implemented in hardware, software, or a combination thereof. In the context of software, the blocks represent computer-executable instructions that, when executed by one or more processors, cause the processors to perform the recited operations. Generally, computer-executable instructions include routines, programs, objects, modules, components, data structures, and the like that perform particular functions or implement particular abstract data types. The order in which the blocks are described is not intended to be construed as a limitation, and any number of the described operations can be combined in any order and/or in parallel to implement the processes. For discussion purposes, the processes 700, 800, 900 are described with reference to FIGS. 1, 2, 3, 4, 5, and 6 as described above, although other models, frameworks, systems and environments may be used to implement these processes.

FIG. 7 is a flowchart of a process 700 that includes part numbers of similar parts ordered based on a similarity score of each similar part to a particular part, according to some embodiments. The process 700 may be performed by the server 104 of FIG. 1.

At 702, the process may create a machine learning quality model. At 704, the process may create a machine learning similarity scoring model. At 706, the process may create a machine learning taxonomy model. At 708, the parts data, the machine learning quality model, the machine learning similarity scoring model, and the machine learning taxonomy model may be used to create an intelligent parts catalog. For example, in FIG. 2, the machine learning models 118 may be created based on the input data 202 that is used to train the machine learning models 118. The input data 202 and the machine learning models 118 may be used to create the intelligent parts catalog 116.

At 710, the process may receive a part number that references a particular part in a product. At 712, the process may look up the part number in the intelligent parts catalog. At 714, the process may provide results that include part numbers of similar parts ordered based on a similarity of each similar part to the particular part. For example, in FIG. 1, the computing device 102 may send the query 112 to the intelligent parts catalog 116 hosted by the server 104. The intelligent parts catalog 116 may look up the part number 114, determine the attributes 120 associated with the part number 114, and identify similar parts 124 based on the attributes 126 associated with each of the similar parts. The intelligent parts catalog 116 may, in response to the query 112, provide the results 122 that include the similar part numbers 124 ordered according to their similarity to the part number 114. In some cases, the similarity score 128 of each of the similar parts 124 may be included in the results 122.

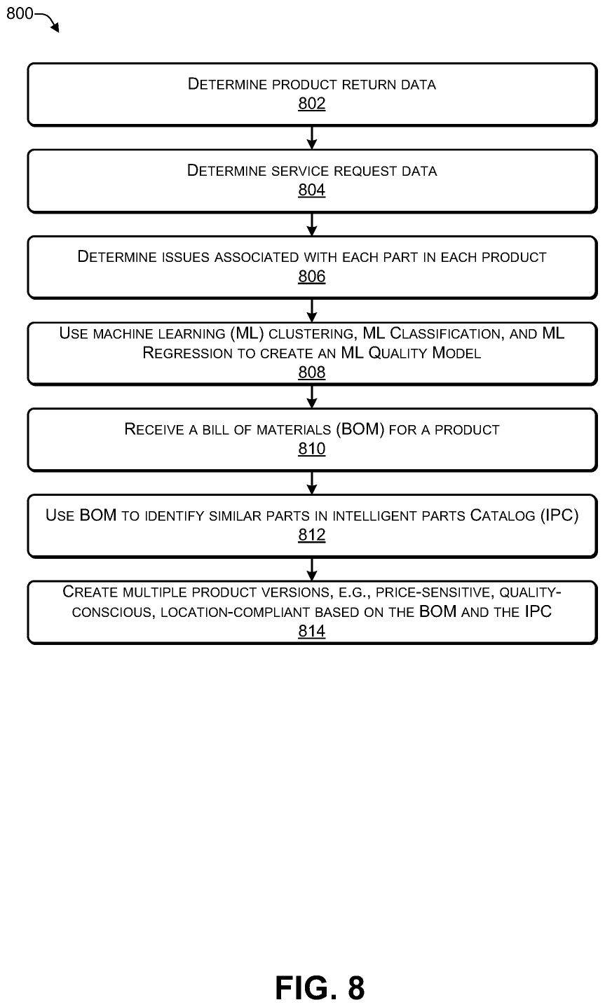

FIG. 8 is a flowchart of a process 800 that includes creating multiple product versions using an intelligent parts catalog, according to some embodiments. The process 800 may be performed by the server 104 of FIG. 1.

At 802, the process may determine product return data. At 804, the process may determine service request data. At 806, the process may determine issues associated with each part in each product (e.g., based on the product return data and the service request data). For example, in FIG. 3, the service request data 204 and the product return data 206 may be used to determine parts reliability data 302 in which each part number 320 may be given a corresponding reliability score 322 that identifies a reliability (e.g., quality) of each part corresponding to the part numbers 320.

At 808, the process may use machine learning clustering, machine learning classification, and machine learning regression to cook to create a machine learning quality model. For example, in FIG. 3, the parts reliability data 302 may be processed using the machine learning clustering 304 two cluster parts having a same or similar reliability score 322. The machine learning classifier 306 may be used to determine, based on the reliability score 322, whether a part is considered sufficiently reliable to be included in a product. For example, parts with a poor reliability score 322 may be considered too unreliable for inclusion in any product. The machine learning regression 308 may place each of the part numbers 320 in a bucket based on the reliability score 322. The result of the machine learning clustering 304, the machine learning classifier 306, and the machine learning regression 308 may be the creation of the machine learning quality model 216.

At 810, the process may receive a bill of materials for a product. At 812, the process may use the bill of materials to identify similar parts in an intelligent parts catalog. At 814, the process may create multiple product versions based on the bill of materials and the intelligent parts catalog, including, for example, a price-sensitive version, a quality conscious version, a location compliant version, and the like. For example, in FIG. 3, the product bill of materials 310 may be provided to the machine learning quality model 216 and the machine learning quality model 216 may provide multiple product versions 312, such as, for example, the quality oriented bill of materials 314, the price oriented bill of materials 316, and the location compliant bill of materials 318. In this way, a manufacturer can use a single bill of materials for a product to create multiple bill of materials for the same product where each of the bill of materials includes parts that are suited for a particular type of market.

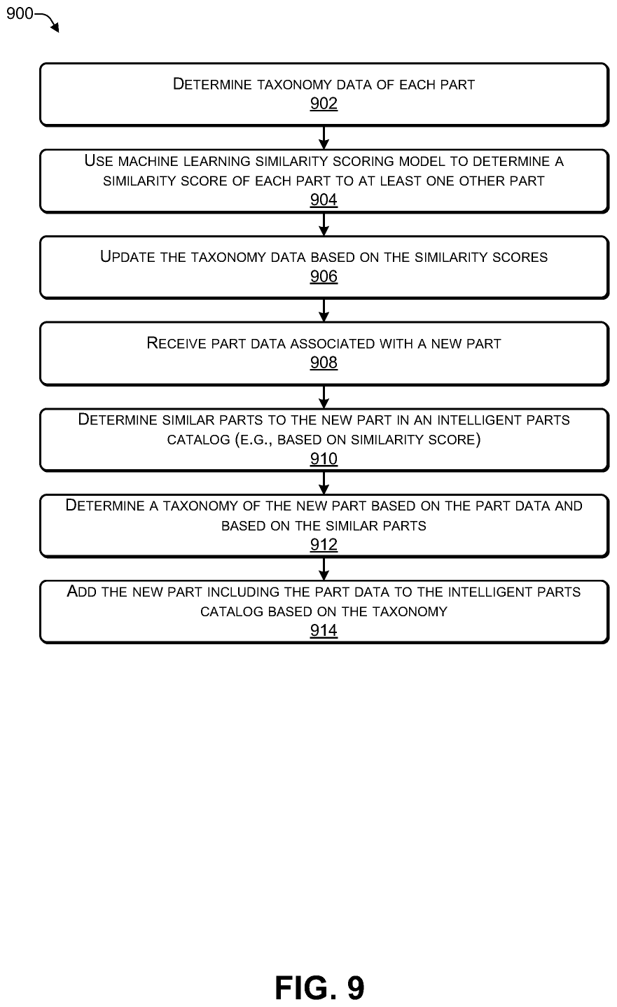

FIG. 9 is a flowchart of a process 900 that includes adding a new part to an intelligent parts catalog based on a taxonomy of the new part, according to some embodiments. The process 900 may be performed by the server 104 of FIG. 1.

At 902, the process may determine taxonomy data of each part being used by a manufacturer. At 904, the process may use a machine learning similarity scoring model to determine a similarity score of each part to at least one other part. At 906, the process may update the taxonomy data based on the similarity scores. For example, in FIG. 6, the machine learning similarity scoring model 218 may process the taxonomy data 210 (e.g., based on catalog information, manufacturer provided information, and the like) to determine the similarity scores 128 and update the taxonomy data 210 to create the updated taxonomy data 602 based on the similarity scores 128.

At 908, the process may receive part data associated with the new part. At 910, the process may determine (e.g., based on the similarity scores) similar parts to the new part in the intelligent parts catalog. At 912, the process may determine a taxonomy of the new part based on the part data and based on the similar parts. At 914, the process may add the new part, including the part data, to the intelligent parts catalog based on the taxonomy. For example, in FIG. 6, the new part data 604 may be provided to the machine learning taxonomy model 220. The machine learning taxonomy model 220 may determine a taxonomy of the new part referenced by the new part data 604 and then provide the update 606 to add the new part and the associated new part data 604 to the intelligent parts catalog 116.

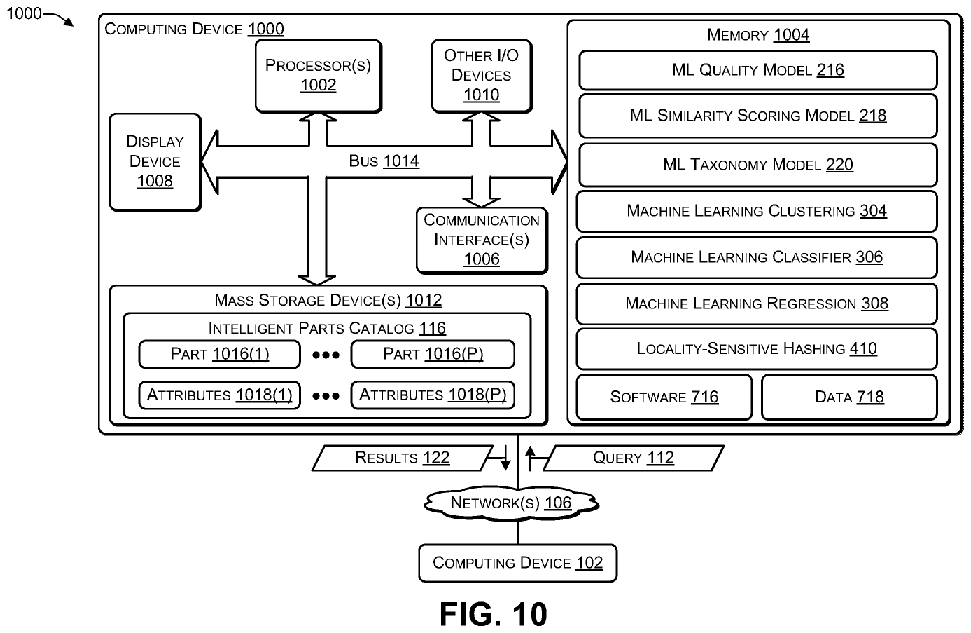

FIG. 10 illustrates an example configuration of a computing device 1000 that can be used to implement the systems and techniques described herein, such as for example, the server 104 (or the computing device 102) of FIG. 1.

The computing device 1000 may include one or more processors 1002 (e.g., including a central processing unit (CPU), a graphics processing unit (GPU), or the like), a memory 1004, communication interfaces 1006, a display device 1008, other input/output (I/O) devices 1010 (e.g., a keyboard, a trackball, and the like), and one or more mass storage devices 1012 (e.g., disk drive, solid state disk drive, or the like), configured to communicate with each other, such as via one or more system buses 1014 or other suitable connections. While a single system bus 1014 is illustrated for ease of understanding, it should be understood that the system buses 1014 may include multiple buses, such as a memory device bus, a storage device bus (e.g., serial ATA (SATA) and the like), data buses (e.g., universal serial bus (USB) and the like), video signal buses (e.g., ThunderBolt®, DVI, HDMI, and the like), power buses, etc.

The processors 1002 are one or more hardware devices that may include a single processing unit or a number of processing units, all of which may include single or multiple computing units or multiple cores. The processors 1002 may include a graphics processing unit (GPU) that is integrated with a CPU or the GPU may be a separate processor device from the CPU. The processors 1002 may be implemented as one or more microprocessors, microcomputers, microcontrollers, digital signal processors, central processing units, graphics processing units, state machines, logic circuitries, and/or any devices that manipulate signals based on operational instructions. Among other capabilities, the processors 1002 may be configured to fetch and execute computer-readable instructions stored in the memory 1004, mass storage devices 1012, or other computer-readable media.

Memory 1004 and mass storage devices 1012 are examples of computer storage media (e.g., memory storage devices) for storing instructions that can be executed by the processors 1002 to perform the various functions described herein. For example, memory 1004 may include both volatile memory and non-volatile memory (e.g., RAM, ROM, or the like) devices. Further, mass storage devices 1012 may include hard disk drives, solid-state drives, removable media, including external and removable drives, memory cards, flash memory, floppy disks, optical disks (e.g., CD, DVD), a storage array, a network attached storage, a storage area network, or the like. Both memory 1004 and mass storage devices 1012 may be collectively referred to as memory or computer storage media herein and may be any type of non-transitory media capable of storing computer-readable, processor-executable program instructions as computer program code that can be executed by the processors 1002 as a particular machine configured for carrying out the operations and functions described in the implementations herein.

The computing device 1000 may include one or more communication interfaces 1006 for exchanging data via the network 106. The communication interfaces 1006 can facilitate communications within a wide variety of networks and protocol types, including wired networks (e.g., Ethernet, DOCSIS, DSL, Fiber, USB etc.) and wireless networks (e.g., WLAN, GSM, CDMA, 802.11, Bluetooth, Wireless USB, ZigBee, cellular, satellite, etc.), the Internet and the like. Communication interfaces 1006 can also provide communication with external storage, such as a storage array, network attached storage, storage area network, cloud storage, or the like.

The display device 1008 may be used for displaying content (e.g., information and images) to users. Other I/O devices 1010 may be devices that receive various inputs from a user and provide various outputs to the user, and may include a keyboard, a touchpad, a mouse, a printer, audio input/output devices, and so forth.

The computer storage media, such as memory 1004 and mass storage devices 1012, may be used to store software and data. For example, the computer storage media may be used to store the machine learning quality model 216, the machine learning similarity scoring model 218, the machine learning taxonomy model 220, the machine learning clustering 304, the machine learning classifier 306, the machine learning regression 308, other software 716, and other data 718. The intelligent parts catalog 116 may be stored in a database hosted by the mass storage devices 1012.

The example systems and computing devices described herein are merely examples suitable for some implementations and are not intended to suggest any limitation as to the scope of use or functionality of the environments, architectures and frameworks that can implement the processes, components and features described herein. Thus, implementations herein are operational with numerous environments or architectures, and may be implemented in general purpose and special-purpose computing systems, or other devices having processing capability. Generally, any of the functions described with reference to the figures can be implemented using software, hardware (e.g., fixed logic circuitry) or a combination of these implementations. The term “module,” “mechanism” or “component” as used herein generally represents software, hardware, or a combination of software and hardware that can be configured to implement prescribed functions. For instance, in the case of a software implementation, the term “module,” “mechanism” or “component” can represent program code (and/or declarative-type instructions) that performs specified tasks or operations when executed on a processing device or devices (e.g., CPUs or processors). The program code can be stored in one or more computer-readable memory devices or other computer storage devices. Thus, the processes, components and modules described herein may be implemented by a computer program product.

Furthermore, this disclosure provides various example implementations, as described and as illustrated in the drawings. However, this disclosure is not limited to the implementations described and illustrated herein, but can extend to other implementations, as would be known or as would become known to those skilled in the art. Reference in the specification to “one implementation,” “this implementation,” “these implementations” or “some implementations” means that a particular feature, structure, or characteristic described is included in at least one implementation, and the appearances of these phrases in various places in the specification are not necessarily all referring to the same implementation.

Although the present invention has been described in connection with several embodiments, the invention is not intended to be limited to the specific forms set forth herein. On the contrary, it is intended to cover such alternatives, modifications, and equivalents as can be reasonably included within the scope of the invention as defined by the appended claims.

1. A computer-implemented method comprising:
receiving, by an intelligent parts catalog hosted by a server, a query comprising a part number corresponding to a particular part used to manufacture a product;
determining, by the intelligent parts catalog, a particular set of attributes associated with the particular part;
performing, by the intelligent parts catalog, a comparison of the particular set of attributes to individual sets of attributes associated with individual part numbers in the intelligent parts catalog;
determining, by the intelligent parts catalog, one or more similar parts to the particular part based on the comparison;
determining, by the intelligent parts catalog, a similarity score associated with at least a portion of the individual part numbers;
determining, by the intelligent parts catalog, one or more similar parts to the particular part based on the associated similarity score; and
providing, by the intelligent parts catalog, results including one or more similar part numbers corresponding to the one or more similar parts, the one or more similar part numbers ordered in descending order based on the associated similarity score.

2. The computer-implemented method of claim 1, further comprising:
determining service request data associated with a plurality of products;
determining product return data associated with the plurality of products;
determining a reliability score associated with individual parts used in the plurality of products based at least in part on the service request data and the product return data;
clustering the individual parts having a similar reliability score using machine learning clustering, wherein a first part and second part have the similar reliability score when a first reliability score of the first part and a second reliability score of the second part differ by less than a predetermined amount, wherein the reliability score is added as an attribute to a set of attributes associated with the individual parts;
classifying, using a machine learning classifier, the individual parts, based on the reliability score associated with the individual parts; and
creating a machine learning quality model based on the parts catalog and the reliability score associated with the individual parts.

3. The computer-implemented method of claim 2, further comprising:
determining price data associated with the individual parts;
adding the price data as an attribute to individual sets of attributes associated with the individual parts; and
receiving a bill of materials identifying a particular set of parts used to build a product.

4. The computer-implemented method of claim 3, further comprising:
determining a first set of parts comprising reliable parts having a reliability score greater than a first threshold amount, the first set of parts used to build the product for a quality-conscious market.

5. The computer-implemented method of claim 3, further comprising:
determining a second set of parts comprising inexpensive parts having a reliability score greater than a second threshold amount and a price less than a third threshold amount, the second set of parts used to build the product for a price-sensitive market.

6. The computer-implemented method of claim 3, further comprising:
determining a third set of parts comprising compliant parts that comply with a set of regulations associated with a particular location, the third set of parts used to build the product for the particular location.

7. The computer-implemented method of claim 1, further comprising:
receiving new part data associated with a new part;
determining a new set of attributes associated with the new part based on the new part data;
determining a new similarity score of the new part to at least one other part in the intelligent parts catalog;
adding a taxonomy data attribute to the set of attributes associated with the new part based at least in part on the similarity score; and
updating the intelligent parts catalog to include the new part based at least in part on the similarity score and the taxonomy data attribute.

8. A server comprising:
one or more processors; and
one or more non-transitory computer readable media to store instructions executable by the one or more processors to perform operations comprising:
receiving, by an intelligent parts catalog hosted by the server, a query comprising a part number corresponding to a particular part used to manufacture a product;
determining a particular set of attributes associated with the particular part;
performing a comparison of the particular set of attributes to individual sets of attributes associated with individual part numbers in the intelligent parts catalog;
determining one or more similar parts to the particular part based on the comparison;
determining a similarity score associated with at least a portion of the individual part numbers;
determining one or more similar parts to the particular part based on the associated similarity score; and
providing results including one or more similar part numbers corresponding to the one or more similar parts, the one or more similar part numbers ordered in descending order based on the associated similarity score.

9. The server of claim 8, further comprising:
determining service request data associated with a plurality of products;
determining product return data associated with the plurality of products;
determining a reliability score associated with individual parts used in the plurality of products based at least in part on the service request data and the product return data;
clustering the individual parts having a similar reliability score using machine learning clustering, wherein a first part and second part have the similar reliability score when a first reliability score of the first part and a second reliability score of the second part differ by less than a predetermined amount, wherein the reliability score is added as an attribute to a set of attributes associated with the individual parts;
classifying, using a machine learning classifier, the individual parts, based on the reliability score associated with the individual parts; and
creating a machine learning quality model based on the parts catalog and the reliability score associated with the individual parts.

10. The server of claim 9, further comprising:
determining price data associated with the individual parts;
adding the price data as an attribute to individual sets of attributes associated with the individual parts; and
receiving a bill of materials identifying a particular set of parts used to build a product.

11. The server of claim 10, further comprising:
determining a first set of parts comprising reliable parts having a reliability score greater than a first threshold amount, the first set of parts used to build the product for a quality-conscious market.

12. The server of claim 10, further comprising:
determining a second set of parts comprising inexpensive parts having a reliability score greater than a second threshold amount and a price less than a third threshold amount, the second set of parts used to build the product for a price-sensitive market.

13. The server of claim 10, further comprising:
determining a third set of parts comprising compliant parts that comply with a set of regulations associated with a particular location, the third set of parts used to build the product for the particular location.

14. The server of claim 8, further comprising:
determining parts data associated with each part in the intelligent parts catalog;
determining taxonomy data associated with each part in the intelligent parts catalog;
determining the similarity score associated with each part in the parts catalog based at least in part on the parts data and the taxonomy data; and
creating a machine learning taxonomy model based at least in part on the similarity scores.

15. One or more non-transitory computer readable media to store instructions executable by the one or more processors to perform operations comprising:
receiving a query comprising a part number corresponding to a particular part used to manufacture a product;
determining a particular set of attributes associated with the particular part;
performing a comparison of the particular set of attributes to individual sets of attributes associated with individual part numbers in an intelligent parts catalog;
determining one or more similar parts to the particular part based on the comparison;
determining a similarity score associated with at least a portion of the individual part numbers;
determining one or more similar parts to the particular part based on the associated similarity score; and
providing results including one or more similar part numbers corresponding to the one or more similar parts, the one or more similar part numbers ordered in descending order based on the associated similarity score.

16. The one or more non-transitory computer readable media of claim 15, further comprising:
determining service request data associated with a plurality of products;
determining product return data associated with the plurality of products;
determining a reliability score associated with individual parts used in the plurality of products based at least in part on the service request data and the product return data;
clustering the individual parts having a similar reliability score using machine learning clustering, wherein a first part and second part have the similar reliability score when a first reliability score of the first part and a second reliability score of the second part differ by less than a predetermined amount, wherein the reliability score is added as an attribute to a set of attributes associated with the individual parts;
classifying, using a machine learning classifier, the individual parts, based on the reliability score associated with the individual parts; and
creating a machine learning quality model based on the parts catalog and the reliability score associated with the individual parts.

17. The one or more non-transitory computer readable media of claim 16, further comprising:
determining price data associated with the individual parts;
adding the price data as an attribute to individual sets of attributes associated with the individual parts; and
receiving a bill of materials identifying a particular set of parts used to build a product.

18. The one or more non-transitory computer readable media of claim 17, further comprising:
determining a first set of parts comprising reliable parts having a reliability score greater than a first threshold amount, the first set of parts used to build the product for a quality-conscious market.

19. The one or more non-transitory computer readable media of claim 17, further comprising:
determining a second set of parts comprising inexpensive parts having a reliability score greater than a second threshold amount and a price less than a third threshold amount, the second set of parts used to build the product for a price-sensitive market.

20. The one or more non-transitory computer readable media of claim 17, further comprising:
determining a third set of parts comprising compliant parts that comply with a set of regulations associated with a particular location, the third set of parts used to build the product for the particular location.
